(19) United States
(12) Patent Application Publication
(10) Pub. No.: US 2017/0046005 A1
(43) Pub. Date: Feb. 16, 2017

(54) AVOIDING NOISE WHEN USING MULTIPLE CAPACITIVE MEASURING INTEGRATED CIRCUITS

(71) Applicant: CIRQUE CORPORATION, Salt Lake City, UT (US)

(72) Inventors: Brian Monson, Farmington, UT (US); David C. Taylor, West Jordan, UT (US)

(21) Appl. No.: 15/233,132

(22) Filed: Aug. 10, 2016

Related U.S. Application Data
(60) Provisional application No. 62/204,248, filed on Aug. 12, 2015.

(51) Int. Cl. G06F 3/041; G06F 3/044

(52) U.S. Cl. CPC G06F 3/0418; G06F 3/044

(57) ABSTRACT

A system and method for enabling noise avoidance between multiple capacitive touch sensing circuits operating in a same device and which may interfere with each other, wherein a master controller is coupled to all of the capacitive touch sensing circuits to prevent them from using measurement frequencies and from jumping to new measurement frequencies that may interfere with each other, thereby allowing the capacitive touch sensing circuits to function properly.

### BACKGROUND OF THE INVENTION

Field of the Invention

This invention relates generally to touch sensors that use capacitive sensing technology. Specifically, the invention pertains to a system and method for avoiding noise when using multiple capacitive touch sensing circuits, and particularly interference from one to another.

Description of the Prior Art

There are several designs for capacitive touch sensing circuits which may take advantage of a system and method for providing a system that enables simultaneous use of capacitive touch sensing circuits in a same device. It is useful to examine the underlying technology of the touch sensors to better understand how any capacitive touch sensor can take advantage of the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Using an equation that compares the magnitude of the two signals measured then performs pointing object position determination.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention. The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing.

It should be understood that use of the term “touch sensor” throughout this document may be used interchangeably with “forcepad”, “touchpad”, “proximity sensor”, “touch and proximity sensor”, “touch panel”, “touchpad” and “touch screen”.

### BRIEF SUMMARY OF THE INVENTION

In a first embodiment, the present invention is a system and method for enabling noise avoidance between multiple capacitive touch sensing circuits operating in a same device or an adjacent environment and which may interfere with each other, wherein a master controller is coupled to all of the capacitive touch sensing circuits to prevent them from using measurement frequencies and from jumping to new measurement frequencies that may interfere with each other, thereby allowing the capacitive touch sensing circuits to function properly.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of operation of a touchpad that is found in the prior art, and which is adaptable for use in the present invention.

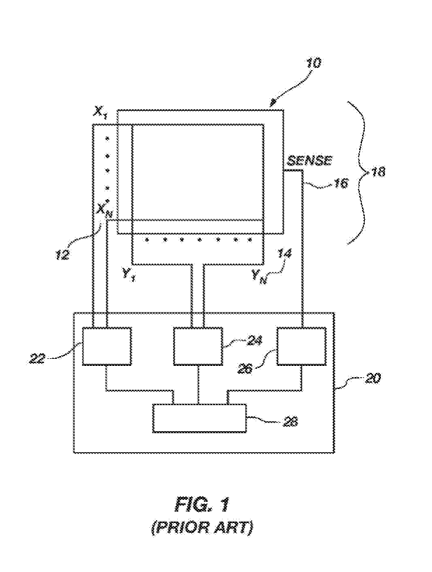

FIG. 2 is a flowchart of a first method of interference avoidance using the first embodiment of the invention.

FIG. 3 is a flowchart of a second method of interference avoidance using the first embodiment of the invention.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

In a first embodiment of the invention, there may be devices that require the use of more than one capacitive touch sensing circuit. For example, in a virtual reality (VR) controller, there may be a plurality of capacitive touch sensing circuits that are in operation at the same time. This is because there may be a need to be able to track the position of multiple fingers, the palm of a hand, or even fingers from two hands on a VR controller that a user may be touching.

For example, the user may be gripping the VR controller and using a trigger, while at the same time providing other buttons for other fingers. Alternatively, the user may be gripping the VR controller with one hand while also providing a touchpad on the top of the controller that may be manipulated by the other hand. The example of a VR controller should not be considered as limiting but only one example of a device that may incorporate at least two capacitive touch sensing circuits in the same device.

Most devices that incorporate a single capacitive touch sensing circuit have had to deal with noise and methods to either reduce noise or avoid noise in order to operate using a touch sensor. For example, the prior art has used frequency hopping to avoid noisy frequencies of operation. However, when using a device that incorporates more than one capacitive touch sensing circuit, the problem of noise becomes more complicated. Two independently operating capacitive touch sensing circuits may inadvertently end up selecting the same frequencies when trying to avoid noise if they are programmed to use the same measurement frequencies when avoiding noise. Thus, the problem that is addressed by the present invention is how to avoid interference between two or more capacitive touch sensing circuits that are operating in a same device such as a VR controller.

When using more than one capacitive touch sensing circuit that is capable of making capacitive measurements from electrodes, the measurement circuits may potentially interfere with each other if they use a prior art method of noise avoidance by frequency hopping. A first embodiment of the invention is to use capacitive touch sensing circuits that are preprogrammed to select measurement frequencies that are different from each other.

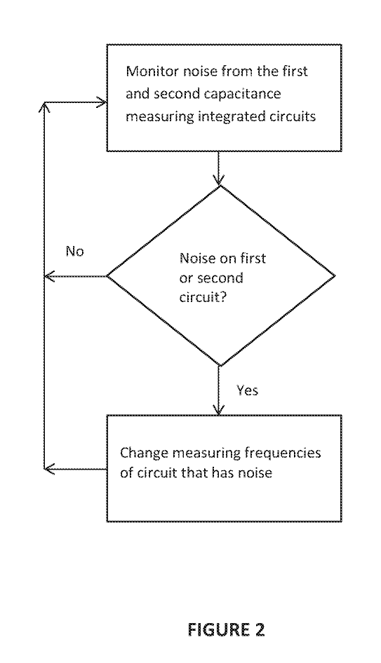

FIG. 2 illustrates the first embodiment of the invention. The first step is to preprogram all of the capacitive touch sensing circuits to have different measurement frequencies. The next step is to monitor noise being detected on the measuring frequency being used by each of the different capacitive touch sensing circuits. The next step is to determine if noise is interfering with a measurement. If noise is causing sufficient interference to be a problem, then the first embodiment changes the measuring frequency of any of the capacitive touch sensing circuits that are having difficulty making a measurement. If no noise was detected that required the measurement frequency of any of the capacitive touch sensing circuits to be changed, then the first embodiment continuously monitors for noise until noise is detected that does require a change in measurement frequency.

This method uses frequency hopping to avoid noise, but requires that all of the measuring frequencies being used are different in each of the capacitive touch sensing circuits. One problem with using this method of frequency hopping is that any capacitive touch sensing circuits that fail must be replaced with a capacitive touch sensing circuits having the same measurement frequencies. This may be difficult to do if the preprogrammed measurement frequencies on each capacitive touch sensing circuits are not known or are difficult to determine.

Another problem that may occur is that because the capacitive touch sensing circuits are operating independently of each other, they may actually cause the very interference they are trying to avoid. For example, the capacitive touch sensing circuits typically include a set of four possible measurement frequencies. Noise from other sources may prohibit the use of some frequencies. However, a capacitive touch sensing circuit may be causing interference on a remaining measurement frequency. There is no method for coordinating with the capacitive touch sensing circuit that is causing interference.

Accordingly, a second embodiment may avoid the problem presented by the method of uncoordinated frequency hopping in the first embodiment. In the second embodiment, a master controller is provided which is coupled to all of the capacitive touch sensing circuits. The capacitive touch sensing circuits are no longer operating independently of each other but are instead being controlled by the master controller.

The master controller may be connected to all of the capacitive touch sensing circuits that are provided in a single device. The purpose of the master controller is to coordinate operation of all the separate capacitive touch sensing circuits. By providing a means for coordinating operation of all the separate capacitive touch sensing circuits, it may be possible to efficiently enable the capacitive touch sensing circuits to avoid noise while at the same time avoid interfering with each other.

For example, consider the problem presented by the first embodiment of the invention. A first capacitive touch sensing circuit may have a single measurement frequency available to it because of noise interference on its other possible frequencies. But that single measurement frequency might be in use by a second capacitive touch sensing circuit. However, the second capacitive touch sensing circuit may have another measurement frequency that it can also use. With the master controller, the second capacitive touch sensing circuit may be instructed to switch to one of the other measurement frequencies that are available. The first capacitive touch sensing circuit may then use its only available measurement frequency that has been made available.

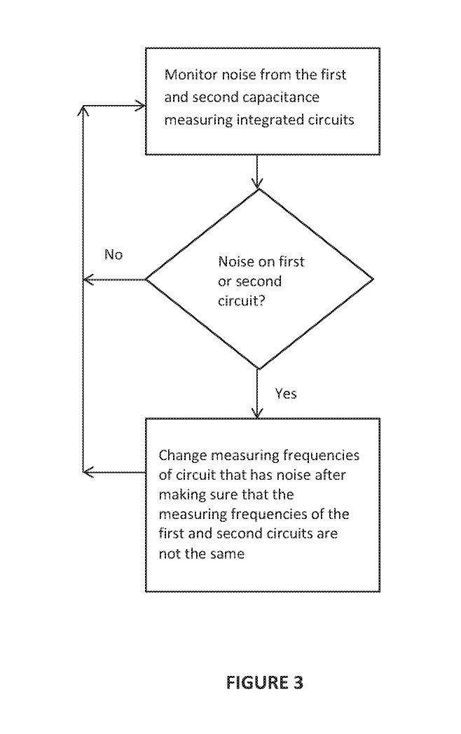

Accordingly, the second embodiment of the invention is shown in FIG. 3. A first difference of the second embodiment is that preprogramming of measurement frequencies is no longer required because the master controller will know which measurement frequencies are being used by all of the capacitive touch sensing circuits in the device. Thus, all of the capacitive touch sensing circuits may now be identical and not require preprogramming.

The first step of the second embodiment is to monitor noise on the measuring frequencies of all the capacitive touch sensing circuits.

The next step is to determine if there is noise on any of the measurement frequencies that will prevent the accurate collection of data from a measurement frequency.

If there is noise, then the next step is to change the measurement frequency on all of the capacitive touch sensing circuits using the master controller. The new measurement frequencies may be selected so as to not cause interference with capacitive touch sensing circuits that do not have noise interference. The selection of new measurement frequencies will be much more efficient because the selection is not being made blindly. The master controller already knows the measurement frequencies being used and may therefore avoid any potential interference that could be caused by a new measurement frequency.

These methods of interference avoidance may be implemented by a hardware or software controller that enables the different measurement circuits to monitor for noise, to automatically change measurement frequencies when noise is detected, and to avoid using the same measurement frequencies as another measurement circuit.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for decreasing interference between at least two capacitive touch sensing circuits, said method comprising:
providing a first capacitive touch sensing circuits;
providing a second capacitive touch sensing circuit, wherein the first capacitive touch sensing circuit and the second capacitive touch sensing circuit are operating in an adjacent environment that enables interference between them;
providing a master controller circuit that is coupled to the first and second capacitive touch sensing circuits and which controls the measurement frequencies selected by the first and second capacitive touch sensing circuits;
monitoring noise that is measured by the first and second capacitive touch sensing circuits; and
using the master controller circuit to select a new measurement frequency for the first or second capacitive touch sensing circuits when noise is detected that interferes with operation of the first or second capacitive touch sensing circuits changing measuring frequencies of the first capacitive touch sensing circuit when noise is detected, wherein the new measurement frequency is selected so that it does not interfere with operation of the other capacitive touch sensing circuit.
